(19) United States
(12) Patent Application Publication
(10) Pub. No.: US 2026/0137968 A1
(43) Pub. Date: May 21, 2026

(54) FIRE SUPPRESSION SYSTEM OF ELECTRIC VEHICLE CHARGING STATION

(71) Applicant: LEE MOBILITY INC., Daejeon (KR)

(72) Inventor: Jae Hwan LEE, Daejeon (KR)

(73) Assignee: LEE MOBILITY INC., Daejeon (KR)

(21) Appl. No.: 18/554,218

(22) PCT Filed: Sep. 14, 2023
(86) PCT No.: PCT/KR2023/013767

§ 371 Date: Jan. 13, 2026

(30) Foreign Application Priority Data
May 10, 2023 (KR) 10-2023-0060434
Jul. 12, 2023 (KR) 10-2023-0090301

(51) Int. Cl. A62C 3/16; A62C 31/22; A62C 37/38

(52) U.S. Cl. CPC A62C 3/16; A62C 31/22; A62C 37/38

(57) ABSTRACT

The present disclosure relates to a fire suppression system of an electric vehicle charging station and, more particularly, to a fire suppression system of an electric vehicle charging station, which analyzes camera image information of an electric vehicle charging station to detect and respond to a charging fire in advance, unfolds a flame-retardant cover of a fire blocking/extinguishing apparatus installed above an electric vehicle in the event of a fire to prevent the spread of flame, sprays a fire extinguishing agent to the inside of the flame-retardant cover while storing the sprayed fire extinguishing agent to provide a water bath function, causes a sharp-edged bar of a perforating fire extinguishing apparatus installed on the floor of the charging area to protrude and penetrate an electric vehicle battery to enter the same, and causes the sharp-edged bar to directly inject the fire extinguishing agent into the battery to suppress the chain reaction, thereby quickly suppressing the fire by simultaneously approaching from the outside and inside of the electric vehicle.

### TECHNICAL FIELD

The present disclosure relates to a fire suppression system of an electric vehicle charging station and, more particularly, to a fire suppression system of an electric vehicle charging station, which analyzes camera image information of an electric vehicle charging station to detect and respond to a charging fire in advance, unfolds a flame-retardant cover of a fire blocking/extinguishing apparatus installed above an electric vehicle in the event of a fire to prevent the spread of flame, sprays a fire extinguishing agent to the inside of the flame-retardant cover to extinguish fire while storing the fire extinguishing agent, thereby providing a water bath function, when the level of the retained fire extinguishing agent reaches a certain level, discharges the excess amount of agent to the outside to reduce the spray amount of the fire extinguishing agent, thereby reducing the use amount of the fire extinguishing agent, and causes a sharp-edged bar of a perforating fire extinguishing apparatus to protrude from the bottom of a charging area and penetrate an electric vehicle battery case to enter the battery such that the sharp-edged bar directly injects the fire extinguishing agent into the battery to suppress the chain reaction, thereby quickly suppressing the fire by simultaneously approaching from the outside and inside of the electric vehicle.

### BACKGROUND ART

In general, automobiles have used internal combustion engines that use gasoline or diesel fuel, but recently, in consideration of the problem of carbon dioxide emitted from the internal combustion engines, electric vehicles, which are eco-friendly energy vehicles, have proliferated. With regard to this trend, more and more internal combustion engine vehicles will be phased out all around the world due to global warming, whereas the supply of electric vehicles is steadily increasing every year, and the market share according thereto will increase further in the future.

The battery, which is the most important element in these electric vehicles, is configured as a battery pack by providing a plurality of battery modules therein so as to be used for a long time with a single charge and is then mounted to the lower part of the vehicle for use. The battery pack may catch fire due to various causes including an external impact, which may occur while driving or charging.

In particular, during charging, an abnormal operation between the charging apparatus and the battery or an abnormality caused by a damaged battery may rapidly increase the heat from the battery leading to a burning reaction of the battery, thereby causing fire.

Therefore, in recent years, a fire suppression apparatus has been installed in the electric vehicle charging station to prevent the spread of fire by promptly extinguishing fires in the event of an electric vehicle fire.

Korean Patent Registration No. 10-2431474 (registered on Aug. 8, 2022) (hereinafter referred to as “Patent Document 1”) suggested a fire suppression tank of an electric vehicle charging station. In Patent Document 1, a reception body in the form of a square border is formed on the floor at a parking position of a charging station, and a multi-walled tube expanded upward by air injection is provided in the reception body and to form a water tank to contain water. However, since the top thereof is open, the flame may spread to adjacent areas, and it is difficult to introduce the fire extinguishing agent or water to the inside of the battery.

Korean Patent Registration No. 10-2504119 (registered on Feb. 22, 2023) (hereinafter referred to as “Patent Document 2”) suggests a system and a method for detecting fire and preventing spread of fire when charging an electric vehicle. In Patent Document 2, a fire extinguishing fluid injection unit and a roof cover are disposed above an electric vehicle, and in case of fire, a blocking cover unfolds in the blocking cover holding part installed at the edge of the roof cover to form an airtight space enclosing the electric vehicle, and the fire extinguishing fluid is sprayed. However, since the blocking cover comes into loose contact with the floor of the parking area, it is unable to contain the sprayed fire extinguishing fluid therein, and it is difficult to supply the fire extinguishing fluid to the inside of the battery.

Korean Patent Registration No. 10-2470858 (registered on Nov. 22, 2022) (hereinafter referred to as “Patent Document 3”) proposed a suffocating fire extinguishing cover having a water spray structure. In patent document 3, a fire extinguishing cloth covering a vehicle, a fire extinguishing water supply hose, and a water spray cloth having water spray holes, which is coupled to the bottom surface of the fire extinguishing cloth, are configured such that fire extinguishing water flows into the inner space of the water spray cloth so as to be sprayed to the vehicle through the water spray holes. Patent Document 3 has problems in that the fire extinguishing cover is provided on the vehicle on fire without a function of containing fire extinguishing water therein and in which it is difficult to supply the fire extinguishing liquid to the inside of the battery for quick stabilization.

Therefore, a new type of fire suppression system is required for the electric vehicle charging station to collect the sprayed fire extinguishing agent to form a water bath in the event of an electric vehicle fire while preventing the spread of flame and also supply the fire extinguishing agent to the inside of the battery in the early stage of fire, thereby inducing prompt stabilization of the battery.

### DISCLOSURE OF INVENTION

### Technical Problem

A fire suppression system of an electric vehicle charging station of the present disclosure to solve the problems of the prior art described above is to provide a system that

quickly unfolds a flame-retardant cover in the event of fire to prevent the spread of flame, ensures tight contact between the unfolded flame-retardant cover and the floor of a charging area to trap a fire extinguishing agent sprayed to the inside, thereby forming a water bath, if the fire extinguishing agent is retained at a certain level in the internal space, controls the spray amount of the fire extinguishing agent to reduce the amount of fire extinguishing agent used, and directly injects the fire extinguishing agent into the battery at the beginning of fire, thereby realizing prompt stabilization of the battery.

### Solution to Problem

A fire suppression system of an electric vehicle charging station is configured to include:
a charging apparatus installed on one side of a charging area where an electric vehicle is parked and configured to supply electricity to the parked electric vehicle to charge the same; a camera measurement apparatus installed on the front, rear, and floor of the charging area and configured to take general images and thermal images of the electric vehicle; a fire blocking/extinguishing apparatus that includes a multi-folded flame-retardant cover installed above the electric vehicle charging area such that the flame-retardant cover unfolds during fire extinguishing to form a dome-shaped sealed space to cover the electric vehicle, thereby blocking the flame from being exposed to the outside, and a plurality of nozzles formed on the inner surface of the flame-retardant cover so as to spray a fire extinguishing agent supplied from an extinguishing agent tank, thereby extinguishing fire of the electric vehicle enclosed therein; and a control apparatus configured to provide the general images and thermal images received from the camera measurement apparatus to a manager and operate the fire blocking/extinguishing apparatus by receiving an operation signal.

The fire blocking/extinguishing apparatus may further include: a transfer pipe having an inlet connected to the extinguishing agent tank and an outlet disposed above the charging area of the electric vehicle; and a flame-retardant housing mounted in a box shape at the outlet of the transfer pipe and having an opening/closing door on the lower surface thereof, and the flame-retardant cover may be folded and stored inside the flame-retardant housing.

Here, the flame-retardant cover may be configured to include: a dome-shaped main cover formed by laminating flame-retardant materials in a multi-layer; a flow passage formed in a portion of the main cover and configured to transfer the fire extinguishing agent supplied from the extinguishing agent tank, maintain the main cover in a dome shape by the pressure of the fire extinguishing agent, and come into close contact with the floor of the charging area to form a sealed space in which the vehicle is placed; a spray nozzle formed on the side surface of the sealed space in the flow passage to spray the transferred fire extinguishing agent into the sealed space; and a discharge means formed on the main cover that does not have the flow passage and configured to discharge the fire extinguishing agent retained in the sealed space to the outside to prevent the fire extinguishing agent from being stored above a certain level.

In addition, the discharge means may be a plurality of check valves mounted at a height 20 to 30 cm higher than the battery mounting height of the electric vehicle and configured to discharge the stored fire extinguishing agent to the outside.

In addition, the discharge means may be equipped with a detection sensor configured to detect whether or not the fire extinguishing agent is discharged, and when the detection sensor detects the discharge of the fire extinguishing agent, the amount of fire extinguishing agent discharged from the extinguishing agent tank is adjusted to reduce the amount of fire extinguishing agent used.

In addition, the flow passage may be configured to include: a plurality of radial passages radially formed at a point connected to the discharge pipe outlet, configured to unfold the central portion of the flame-retardant cover to the side, and having spray nozzles formed toward the sealed space; vertical passages disposed vertically to have one end leading to the radial passage and a lower portion extending outwards, thereby increasing the internal area, and having spray nozzles formed toward the sealed space; and bottom passages connecting adjacent vertical passages among the plurality of vertical passages to close the same in a circle or rectangular shape and coming into close contact with the floor of the charging area by the weight of the fire extinguishing agent injected therein, thereby retaining the fire extinguishing agent sprayed therein.

Meanwhile, a perforating fire extinguishing apparatus configured to move a plurality of sharp-edged bars up in case of fire of the electric vehicle battery so as to penetrate the bottom of the electric vehicle and enter the battery, inject the fire extinguishing agent supplied from the extinguishing agent tank into the battery through the sharp-edged bars, thereby extinguishing the fire, may be buried in the floor of the electric vehicle charging area, and

the control apparatus may be configured to operate one of either the fire blocking/extinguishing apparatus or the perforating fire extinguishing apparatus or both of them for fire suppression.

The perforating fire extinguishing apparatus may be configured to include: a perforating housing buried in the floor of the electric vehicle charging area to provide an installation space; a sharp-edged bar installed vertically inside the perforating housing and having an agent supply pipe configured to supply the fire extinguishing agent of the extinguishing agent tank, which is connected to one side of the lower portion thereof, and a perforated outlet configured to discharge the fire extinguishing agent supplied through the agent supply pipe to the outside through an internal passage, which is formed at the upper end or one side of the upper portion; and a hydraulic/pneumatic cylinder configured to transfer hydraulic/pneumatic pressure to the sharp-edged bar to move the same up and down.

In addition, the perforating fire extinguishing apparatus may be configured to include: a perforating housing buried in the floor of the electric vehicle charging area to provide an installation space; a plurality of guide walls arranged in a wall structure in parallel at regular intervals on the bottom inside the perforating housing and having vertical guide holes formed on opposite inner surfaces; an inclined plate, which is a triangular wall having an inclined surface from the front to the rear on the upper surface thereof, installed to move forward and backward in the longitudinal direction between the two guide walls disposed in parallel; a hydraulic/pneumatic cylinder connected to the rear side of the inclined plate and moving the inclined plate forward and backward; a lifting block having lifting protrusions formed on both sides to be inserted into the vertical guide holes of the guide walls so as to move only in the vertical direction and an inclined surface, corresponding to the inclined surface of the inclined plate, formed on a partial or entire surface of the rear side of the bottom to slide along the inclined plate, thereby moving up and down; and a sharp-edged bar vertically installed on the upper portion of the lifting block and having an agent supply pipe configured to supply the fire extinguishing agent of the extinguishing agent tank, which is connected directly or through the lifting block to one side of the lower portion thereof and a perforated outlet configured to discharge the fire extinguishing agent supplied through the agent supply pipe to the outside through an internal passage, which is formed at the upper end or one side of the upper portion.

The control apparatus of the present disclosure may perform control including: an image measurement step of securing an image of the electric vehicle through the camera measurement apparatus; an image analysis step of checking whether or not smoke or flame is generated through measured image information and continuously analyzing whether or not the battery temperature is higher than a configured temperature to identify a pattern; a pattern determination step of comparing an analysis pattern of the image information analyzed in the image analysis step with a stored pattern to determine whether the pattern is a normal pattern or an abnormal pattern; a manager confirmation information input step of, when the analysis pattern of the image information is determined to be similar to the abnormal pattern, giving a notification to a manager through an alarm while cutting off the charging power or transmitting the image to a registered manager terminal and receiving confirmation information to confirm whether there is a fire; a final decision step of, when manager confirmation information is filling a fire extinguishing agent, connecting to a registered fire station terminal to provide image information and receiving fire extinguishing execution information from the fire station terminal; and a fire extinguishing apparatus operation step of supplying power to a single or a plurality of fire extinguishing apparatus to be operated when the fire extinguishing execution information is received.

### Advantageous Effects of Invention

A fire extinguishing apparatus for suppressing an electric vehicle battery fire of the present disclosure according to the solutions to problems may have

a fire blocking/extinguishing apparatus installed above a charging station, which quickly unfolds a built-in flame-retardant cover in the event of fire including abnormal symptoms to seal the electric vehicle from the external space, thereby preventing the spread of flame.

In addition, a flow passage formed in the flame-retardant cover may expand by the supply pressure of the fire extinguishing agent and serve as a framework of the flame-retardant cover to form a dome-shaped closed space inside the flame-retardant cover so that the fire extinguishing agent may be sprayed onto the side and top of the electric vehicle by a plurality of spray nozzles formed in the flame-retardant cover forming the flow passage, enabling quick suppression of fire.

In addition, a closed annular or rectangular bottom flow passage may be formed even in a portion of the flame-retardant cover in contact with the floor of the parking and charging area to enclose the electric vehicle such that the weight of the bottom flow passage makes the cover to come into close contact with the floor of the charging area, sealing the inside, so it is possible to extinguish a fire through a water bath effect in which a certain amount of sprayed fire extinguishing agent is retained such that the battery is immersed therein, enabling rapid fire extinguishing.

In addition, if a sufficient amount of fire extinguishing agent is retained in the flame-retardant cover, the surplus fire extinguishing agent may be discharged to the outside through a discharge means, and at the same time, the amount of fire extinguishing agent sprayed into the flame-retardant cover may be reduced, whereby it is possible to provide an eco-friendly flame-retardant cover capable of minimizing environmental pollution by reducing the amount of fire extinguishing agent used.

In addition, a perforating fire extinguishing apparatus may be buried in the floor of the charging area, and the battery of the electric vehicle may be perforated by a sharp-edged bar during the fire suppression work such that the fire extinguishing agent is directly introduced into the battery to prevent further explosion through battery stabilization, so it is possible to suppress electric vehicle fires by rapid stabilization by simultaneously performing internal and external fire extinguishing works.

### BRIEF DESCRIPTION OF DRAWINGS

FIG. 1 is a perspective view illustrating the state in which a fire blocking/extinguishing apparatus according to a preferred embodiment of the present disclosure operates.

FIGS. 2A to 2C are vertical cross-sectional views illustrating the states before and after the operation of a fire blocking/extinguishing apparatus according to the present disclosure and the state in which a retained fire extinguishing agent is discharged.

FIGS. 3A and 3B are a plan view and a side view illustrating the top and the side of a flame-retardant cover in an unfolded state.

FIGS. 3C and 3D are vertical cross-sectional views illustrating various shapes of the lower end of flame-retardant cover according to the present disclosure.

FIG. 4 is a block diagram illustrating a control step of a control apparatus according to the present disclosure.

FIGS. 5A and 5B are schematical cross-sectional views of a perforating fire extinguishing apparatus according to the present disclosure.

FIG. 6A is a plan view illustrating another embodiment of a perforating fire extinguishing apparatus according to the present disclosure, and FIGS. 6B and 6C are operational state diagrams thereof.

### BEST MODE FOR CARRYING OUT THE INVENTION

Hereinafter, embodiments of the present disclosure will be described in detail with reference to the accompanying drawings. The present disclosure may have various modifications and various forms, so the present disclosure will be described in detail below through specific embodiments and drawing showing the same. However, this is not intended to limit the present disclosure to specific disclosures and should be understood to include all modifications, equivalents, and substitutes included in the spirit and scope of the present disclosure. Like reference numerals have been used for like elements throughout the drawings to be described. In the accompanying drawings, the dimensions of the structures are shown by enlarging or reducing actual sizes for clarity of the present disclosure.

Terms used in this application are only used to describe specific embodiments and are not intended to limit the present disclosure. Singular expressions encompass plural expressions unless the context clearly dictates otherwise. In this application, the terms such as “include”, “provide”, or “have” should be understood to indicate the presence of a feature, number, step, operation, element, or a combination thereof described in the specification, but not to preclude the presence or addition of one or more other features, numbers, steps, operations, elements, or combinations thereof.

Unless defined otherwise, all terms used herein, including technical or scientific terms, have the same meaning as commonly understood by those of ordinary skill in the art to which the present disclosure pertains. The terms commonly used and defined in dictionaries are to be interpreted to have a meaning consistent with the meaning in the context of the related art, and unless explicitly defined in this application, they are not to be interpreted as ideal or excessively formal meanings.

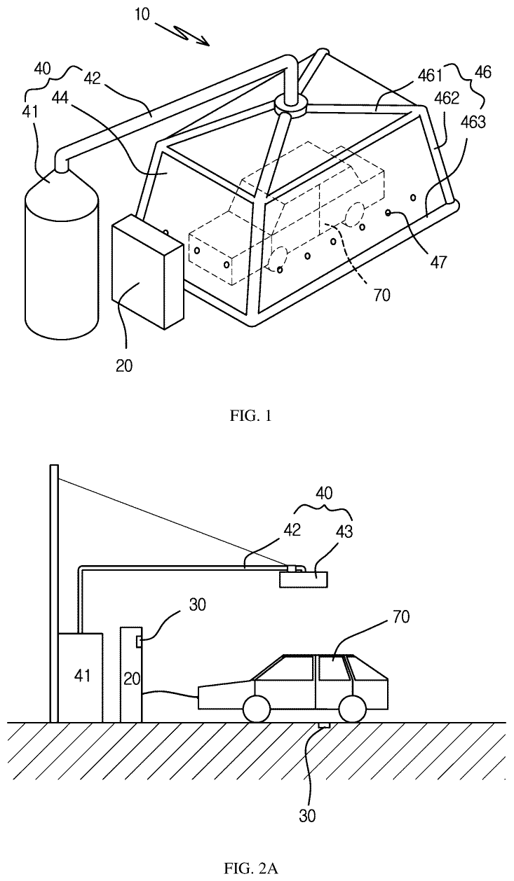

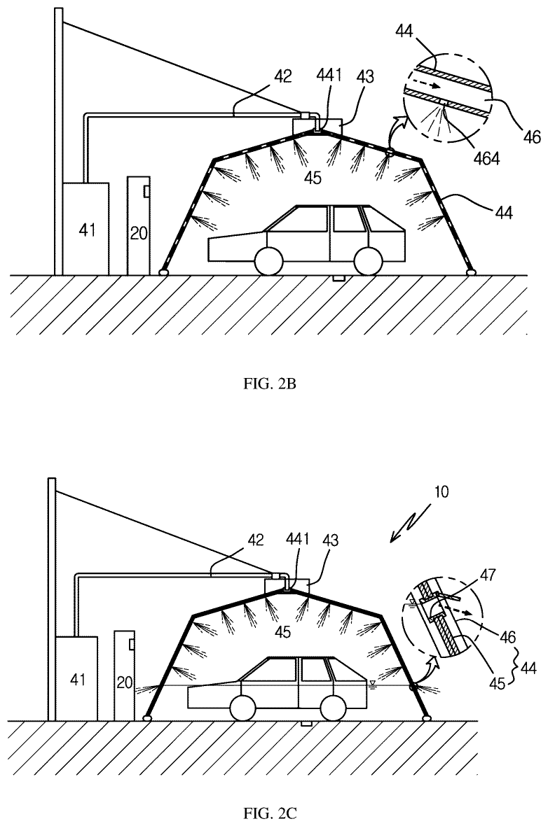

FIG. 1 is a perspective view illustrating the state in which a flame-retardant cover according to a preferred embodiment of the present disclosure operates, FIGS. 2A and 2B are vertical cross-sectional views illustrating the states before and after the operation of a fire blocking/extinguishing apparatus according to the present disclosure, and FIG. 2C is a vertical cross-sectional view illustrating a structure for discharging a fire extinguishing agent retained in a flame-retardant cover.

Referring to the drawings, a fire suppression system 10 of an electric vehicle charging station according to the present disclosure is configured to include a charging apparatus 20 installed at one side of a charging area where an electric vehicle is parked, a camera measurement apparatus 30 installed on the front, rear, and floor of the charging area and measuring an image of the electric vehicle parked for charging, and a fire blocking/extinguishing apparatus 40 that quickly covers the electric vehicle in case of electric vehicle fire to prevent the spread of flame and sprays a fire extinguishing agent to the interior space thereof, and a control apparatus 60 (not shown) for controlling various signals.

The charging apparatus 20 is installed in a wall type or stand type in a portion opposite the entrance where the vehicle enters the charging area and has a charging connector to be connected to the parked electric vehicle to charge. Various existing products may be used as the charging apparatus and may also be provided in the form in which a camera measurement apparatus and an extinguishing agent tank, which will be described later, are provided inside the same.

The camera measurement apparatus 30 may be installed in the front charging apparatus, installed at the top and rear of the parked electric vehicle, or installed on both sides thereof, and two or more camera measurement apparatuses may be installed to capture images at various angles. In addition, it may be installed on the floor of the parking area to capture an image of the bottom of the parked electric vehicle.

This camera measurement apparatus 30 photographs and monitors the occurrence of smoke or flame in the electric vehicle, or photographs heat distribution through a thermal imaging camera and provides the same to a control apparatus to be described later. That is, externally identified smoke, flames, or damage to a battery pack housing may be inspected through a general video camera, and abnormalities in the battery or charging line installed in the electric vehicle may be inspected through a thermal imaging camera.

The fire blocking/extinguishing apparatus 40 is configured to have a flame-retardant cover 44 that is folded and provided above the parked electric vehicle so that the flame-retardant cover 44 is unfolded to cover the electric vehicle 70 during fire extinguishing, thereby preventing the spread of flame, and spray a fire extinguishing agent inside the same to extinguish the fire. In particular, the fire extinguishing agent sprayed into the inside may be retained by securing close contact between the flame-retardant cover and the floor of the charging area, thereby suppressing the fire by the water bath function.

The fire blocking/extinguishing apparatus 40 includes an extinguishing agent tank 41 filled with a fire extinguishing agent as shown in FIG. 2A. The extinguishing agent tank 41 may be installed in various forms such as being installed inside the charging apparatus, installed in a stand type on one side of a charging area, or buried. In addition, the fire extinguishing agent contained in the extinguishing agent tank may be various agents used to extinguish electric vehicle fires.

A transfer pipe 42 is connected to one side of the extinguishing agent tank. The inlet of the transfer pipe 42 is connected to the extinguishing agent tank 41 to receive the fire extinguishing agent stored in the extinguishing agent tank, and the outlet thereof is disposed above the parked electric vehicle so as to discharge the fire extinguishing agent. A check valve may be installed at the transfer pipe, the extinguishing agent tank, or a connection portion between the transfer pipe and the extinguishing agent tank so that the fire extinguishing agent stored in the extinguishing agent tank may be transferred and supplied by control of the control apparatus.

A flame-retardant housing 43 is installed at the outlet of the transfer pipe. The flame-retardant housing 43 is coupled to a portion adjacent to the outlet of the transfer pipe 42 and includes a variety of means for storing the flame-retardant cover that is provided in the form of a box having a space capable of containing a flame-retardant cover described later or in the form of a support supporting the flame-retardant cover to not arbitrarily drop down. Here, in the case where the flame-retardant housing 43 is provided in the form of a box, an opening/closing door may be formed on the lower surface thereof such that the flame-retardant cover 44 is discharged by opening and closing thereof. The opening/closing door may be formed of a material that breaks by the expansion force of the internal flame-retardant cover or may be provided in a mechanical structure that is opened and closed by control of a control apparatus. In addition, the flame-retardant housing 43 is provided in a detachable structure from the transfer pipe 42 so as to be replaced after use.

The flame-retardant cover 44 is disposed in the flame-retardant housing and is discharged to the outside and unfolds in a dome shape to cover the electric vehicle during fire suppression, as shown in FIG. 2B, thereby preventing the electric vehicle flame from spreading to the outside.

The flame-retardant cover 44 includes a dome-shaped main cover 45 that is formed by laminating flame-retardant material layers, a flow passage 46 that is formed inside the flame-retardant material layers to transfer the fire extinguishing agent supplied from the extinguishing agent tank, and a spray nozzle 464 that is formed on the inner surface of the flame-retardant cover at the portion where the flow passage is formed to spray the transferred fire extinguishing agent to the inner space of the flame-retardant cover.

It is preferable that the main cover 45 is laminated and bonded in a multi-layer rather than a single layer to form the flame-retardant material layers.

The flow passage 46 forms a space by not partially bonding an inner portion of the laminated flame-retardant material layers. The flow passage formed in the main cover may be entirely connected such that the fire extinguishing agent is supplied into the flow passage to fill the flow passage and transfer the fire extinguishing agent through the flow passage.

The spray nozzle 464 is a nozzle for spraying the fire extinguishing agent supplied through the flow passage, and a plurality of spray nozzles may be formed along the flow passage to spray the fire extinguishing agent into the sealed space inside the flame-retardant cover in various directions, enabling rapid fire extinguishing.

As described above, the flame-retardant cover 44 is connected to the outlet of the transfer pipe through a connector and receives the fire extinguishing agent from the transfer pipe to fill the flow passage 46 of the flame-retardant cover, and the flame-retardant cover unfolds in the dome shape in the process of filling the flow passage.

The connector 441 may be formed of a watertight packing and closely attached to the transfer pipe, and a locking means coupled to the transfer pipe or flame-retardant housing may be further provided to prevent separation thereof by the discharge pressure of the fire extinguishing agent. As the locking means, locking means using various known locking devices may be provided, which include a configuration in which a closed fixing ring is formed in the transfer pipe or flame-retardant housing and in which a locking hook is formed in the connector so that locking is performed by inserting the locking hook into the fixing ring.

In addition, the flame-retardant cover 44 may be provided as a final cover by laminating flame-retardant material fabric in multiple layers and configured to form the flow passage through a sewing method, as well as an adhesive method, and the flow passage serving as a framework of the flame-retardant cover may have a desired thickness by adjusting the attachment interval or sewing interval.

Although the entire space between the multiple flame-retardant material layers may be used as a fire extinguishing agent filling space without the partial attachment or sewing, in this case, it takes a long time to fill the fire extinguishing agent to form the flame-retardant cover in a dome shape, which makes it difficult to quickly extinguish the fire. Therefore, by applying a partial attachment or sewing method to reduce the volume of the flow passage filled with the fire extinguishing agent, it is possible to quickly construct a frame and cover the vehicle in a dome shape, thereby sealing the vehicle.

As shown in FIG. 2C, the present disclosure may further include a discharge means 47 in a portion of the main cover 45 that does not have a flow passage.

The discharge means 47 is a device for discharging the fire extinguishing agent retained inside the flame-retardant cover to the outside, and typically has a check valve, and various other methods of maintaining the internal water level by being opened when a certain water level is reached may be applied thereto.

A plurality of the discharge means is formed at least at a position higher than the height of the battery of the vehicle so that the vehicle battery is immersed in the retained fire extinguishing agent. The discharge means is installed at a position 10 to 50 cm higher than the mounting height of the battery to the vehicle and is preferably formed at a position 20 to 30 cm higher than the mounting height of the battery to the vehicle so that the battery is sufficiently submerged.

In addition, a detection sensor may be further mounted to the discharge means 47 to detect whether or not the fire extinguishing agent is discharged. If the detection sensor detects the discharge of the fire extinguishing agent, the discharge amount of fire extinguishing agent from the extinguishing agent tank 41 may be controlled to be reduced, thereby reducing the amount of the fire extinguishing agent used.

The detection sensor may be connected to a check valve of the control apparatus or the extinguishing agent tank through wired or wireless communication to control the extinguishing agent tank.

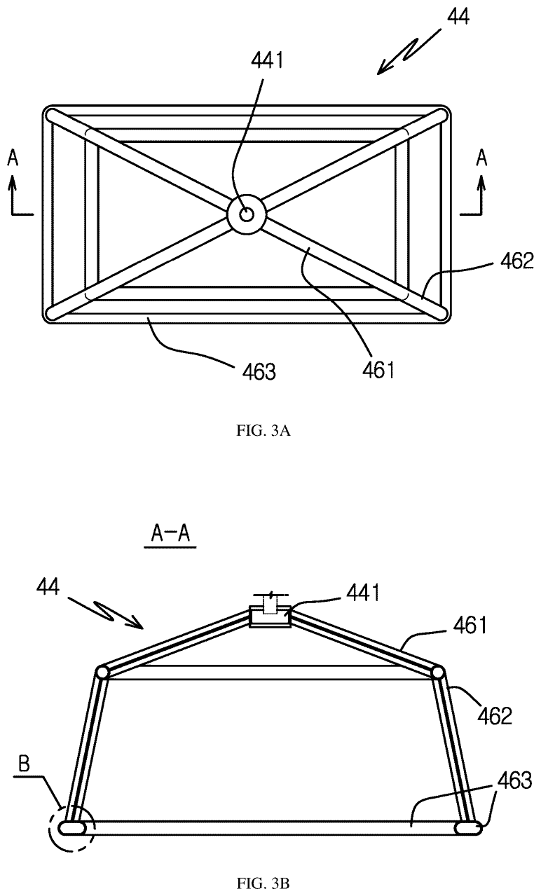

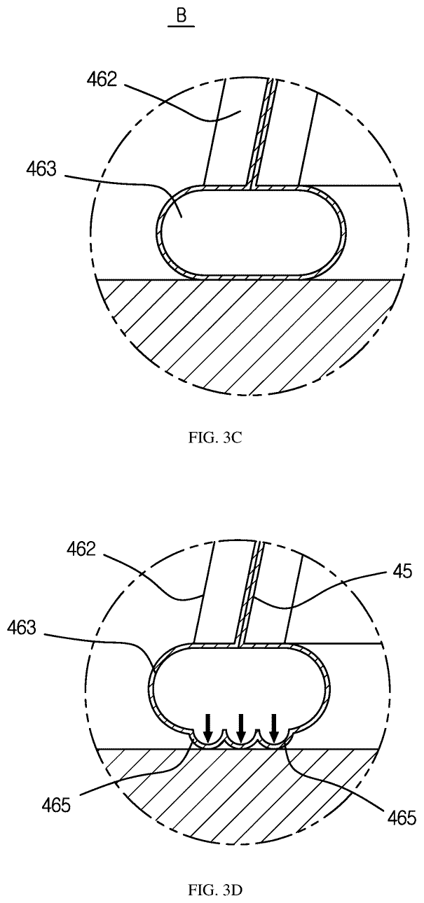

The structure of the flame-retardant cover of the present disclosure will be described in detail with reference to FIGS. 3A and 3B.

The flame-retardant cover 44 of the present disclosure may be provided in a form in which a flow passage 46 through which a fire extinguishing agent is transferred is partially formed. The flow passage 46 may be formed through a portion of the multi-layered main cover that is not partially bonded or sewn, and in addition, the flow passage may be formed in the flame-retardant cover in various methods such as putting a flame-retardant fabric for forming a flow passage over the inner surface of the flame-retardant cover 44.

As shown in FIG. 3A, the flow passage 46 has a connector 441 formed in the center thereof and is coupled to the outlet of the transfer pipe 42 so that a fire extinguishing agent is supplied from the coupled transfer pipe to fill the entire space of the flow passage 46.

When a fire extinguishing agent is supplied into the flow passage 46, the flow passage expands and unfolds due to the supply pressure of the fire extinguishing agent. That is, when the fire extinguishing agent is supplied to the flame-retardant cover 44 folded and stored inside the flame-retardant housing, the flame-retardant cover 44 unfolds while the flow passage 46 is filled with the fire extinguishing agent, and is discharged from the flame-retardant housing during the unfolding of the flow passage to continuously unfold to cover the electric vehicle.

As shown in the drawing, the flow passage 46 includes radial passages 461 extending radially from the connector 441, which is a part connected to the discharge pipe outlet, to form a roof, vertical passages 462 disposed vertically to lead to the radial passages and supporting the radial passages, which constitute the roof of the dome, to be maintained at a certain height, and bottom passages 463 connecting the lower ends of the vertical passages to form a closed circle or polygon and being in close contact with the floor of the electric vehicle charging area.

Although four radial passages 461 are shown in the drawing, four or more radial passages may be provided, and the vertical passages 462 may be arranged in an extended truncated cone shape in which the gaps in the lower portions are greater than those in the upper portions so as to be stably placed on the charging area, and the bottom passage 463 may have a cross section of the passage greater than those of the radial passage and vertical passage to increase the amount of agent therein so that the bottom passage may come into close contact with the charging area by its own weight.

A plurality of spray nozzles 464 may be formed in the radial passages 461, the vertical passages 462, and the bottom passages 463 in the direction to the inner sealed space, and the retained fire extinguishing agent may be sprayed to the electric vehicle 70 placed in the sealed space, thereby performing fire extinguishing. In addition, auxiliary passages may be further formed horizontally between the vertical passages 462, and spray nozzles may be formed in the auxiliary passages to simultaneously spray the fire extinguishing agent in various directions, enabling rapid fire suppression.

In addition, as shown in FIG. 3C, since the bottom passages 463 of the flame-retardant cover 44 is in close contact with the floor of the charging area to provide a certain degree of watertightness, the fire extinguishing agent sprayed to the inside thereof may be retained therein, thereby enabling rapid battery stabilization by a water bath effect in which the electric vehicle battery pack may be immersed in the retained fire extinguishing agent.

In addition, as shown in FIG. 3D, the bottom passage 463 may have multiple rows of convex portions 465 formed long on the bottom surface along the bottom passage, so that the load of the fire extinguishing agent contained in the bottom passage may be more concentrated on the bending point of the convex portion to increase the contact force with the floor of the charging area. The convex portion 465 may be provided in a closed case shape having a triangular or curved cross section to increase the sealing force between the bottom passage and the floor of the charging area.

The control apparatus 60 is a device for controlling various signals in the fire suppression system of an electric vehicle charging station and is installed in the charging apparatus 20 or installed in a safe area separated from charging facilities. The control apparatus checks the charging state and blocks charging in case of an abnormality to ensure safety, receives a general image and thermal image transmitted from the camera measurement apparatus, compares the same with preset comparison data to determine whether there is an abnormality, if there is an abnormality, provides the same to a manager, and receives an operation signal corresponding to the normality or abnormality to operate the fire blocking/extinguishing apparatus.

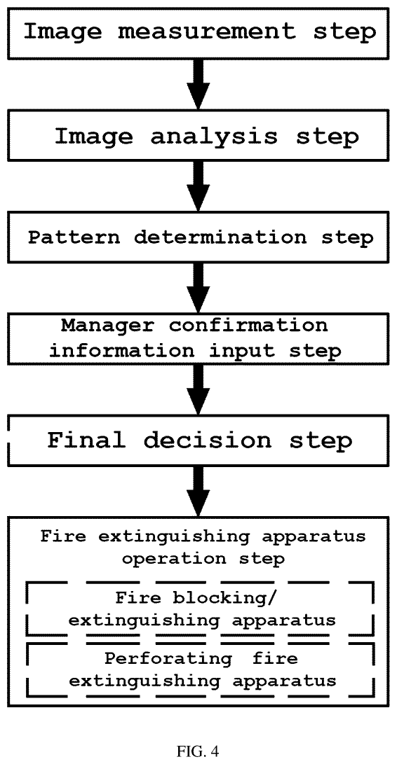

Referring to FIG. 4, an image measurement step is performed to obtain image information by taking a plurality of images of the front, rear, left, right, and top parts of a parked electric vehicle, including the bottom thereof, by the camera measurement apparatus when the electric vehicle is parked in a charging area. In this step, the control apparatus may receive general images and thermal images taken through a plurality of camera measurement apparatuses to perform the next step, and preferably, the next step may be performed after the images are stored in a separate image information DB.

Subsequently, an image analysis step is performed. The control apparatus receives the image information provided from the camera measurement apparatus or the image information stored in the image information DB and determines whether smoke or flame is generated. In addition, a change in temperature of the battery or electricity supply line is measured by analyzing the thermal image. That is, it is basically checked whether smoke or flame is generated by combustion, and it is further checked whether a generated thing is continuously detected and whether it is increased or reduced, thereby generating analysis pattern information. In addition, the temperatures of sensitive parts, for example, the battery where a fire mainly occurs and charging lines including connectors, are measured based on the data from the thermal image to analyze whether or not there is a change in the temperature, thereby generating analysis pattern information.

Next, a pattern determination step is performed. The control apparatus compares the generated analysis pattern information with a stored pattern including the temperature distribution state appearing in the normal charging process to determine whether the analyzed temperature falls within the normal pattern range or belongs to an abnormal pattern falling outside of the normal pattern range.

If it is determined to be an abnormal pattern in the pattern determination step, a manager confirmation information input step is performed. That is, if it is determined to be similar to the abnormal pattern, the control apparatus cuts off the power supplied to the electric vehicle, thereby stopping the charging. In addition, the control apparatus may operate an alarm to notify the manager or user in the charging station of the abnormality so as to perform confirmation and evacuation. In addition, the control apparatus transmits image information including the analysis pattern information to a registered manager terminal to request confirmation and receives confirmation information about subsequent processes from the manager terminal. In this case, it is preferable for the image information transmitted to the manager terminal to display abnormalities caused by flame or smoke so that information about subsequent processes may be promptly input.

Next, the control apparatus performs a final decision step. If the manager confirmation information input from the manager terminal corresponds to a fire, the image information is provided to the nearby fire station server or fire station terminal registered in the control apparatus, and fire extinguishing execution information for executing fire extinguishing work is received from the fire station server or fire station terminal.

For example, if smoke or flame caused by combustion is continuously identified, it may be determined to be a fire, so that the extinguishing agent tank may be opened immediately or within the shortest period of time to extinguish the fire by spraying the fire extinguishing agent. However, if overheating is detected from the thermal image, and if the heat change in the main parts of the vehicle is similar to the pattern leading to a fire (compared to the degree of temperature rise over time) after power is cut off, information is provided so that the person concerned may make a quick judgment, and an operation signal or standby signal is received. The degree of similarity may vary according to settings, but in general, if the similarity is 90% or higher, it is determined that there is a possibility of fire, and information is provided to the fire station terminal or fire station server, and fire extinguishing execution information that is a final decision indicating whether or not spray the fire extinguishing agent is received or information to wait is received from the fire station terminal or fire station server. The final decision on whether or not to spray the fire extinguishing agent is preferably made several tens of seconds before reaching the temperature at which self-ignition occurs due to high heat, but the fire extinguishing is performed after identifying the fire only to prevent further spread of the flame in consideration of a dispute about property of others.

Next, a fire extinguishing apparatus operation step is performed. If fire extinguishing execution information requesting execution of fire extinguishing is received from the fire station terminal or fire station server, power may be supplied to the fire extinguishing apparatus in the charging station so as to be driven. At this time, a single fire extinguishing apparatus may be operated or a plurality of fire extinguishing apparatuses may be simultaneously operated. The fire extinguishing apparatus may include various fire extinguishing apparatus including a fire blocking/extinguishing apparatus and a perforating fire extinguishing apparatus of the present disclosure. Preferably, both the fire blocking/extinguishing apparatus and the perforating fire extinguishing apparatus of the present disclosure may be operated to prevent flame spread and extinguish fire on the exterior of the electric vehicle by the fire blocking/extinguishing apparatus and to realize quick stabilization by the perforating fire extinguishing apparatus perforating the battery at the same time.

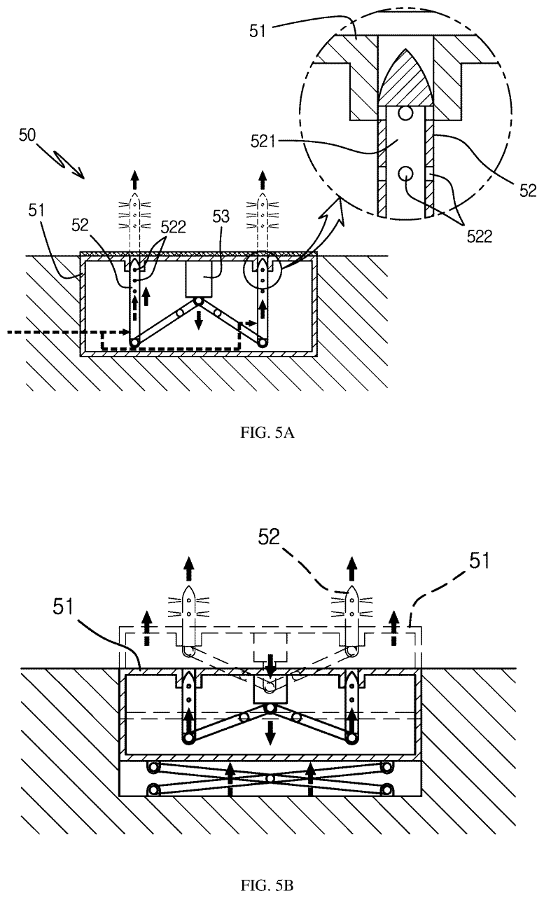

Referring to FIG. 5A, in the present disclosure, a perforating fire extinguishing apparatus may be buried in the floor of the electric vehicle charging area.

The perforating fire extinguishing apparatus 50 is configured to include a perforating housing 51 buried in the floor of the electric vehicle charging area to provide an installation space therein, a sharp-edged bar 52 vertically installed inside the perforating housing, and a hydraulic/pneumatic cylinder 53 for vertically moving the sharp-edged bar up and down.

The perforating housing 51 has high structural strength to maintain its shape even when an electric vehicle steps on it, and a perforation through which the sharp-edged bar is discharged is formed on the upper surface thereof. The perforation may be provided to be exposed, but it may be covered with a rubber plate or the like to prevent dirt from entering from the outside. The rubber plate may be partially formed in the perforation portion or may be configured to cover the entirety of the upper surface of the perforating housing with a layer. In addition, the rubber plate may be formed to be flexible so as to easily break by the lifting pressure when the sharp-edged bar moves up through the perforation and come into close contact with the outer surface of the sharp-edged bar after the breakage, thereby minimizing inflow of the fire extinguishing agent into the perforating housing through the perforated portion. A packing may also be attached to the inner peripheral surface of the perforation so as to come into close contact with the sharp-edged bar moving up and down, thereby providing watertightness.

In addition, the sharp-edged bar 52 has a sharp point formed at the upper end thereof so as to penetrate the lower part of the vehicle body, and is connected to the extinguishing agent tank at the lower portion thereof through an agent supply pipe to receive a fire extinguishing agent, and an internal passage 521 is formed therein, and a plurality of perforated outlets 522 connected with the internal passage 521 are formed in the lateral direction on the upper portion. Accordingly, the fire extinguishing agent supplied from the extinguishing agent tank may be transferred to the perforated outlets 522 through the internal passage 521 inside the sharp-edged bar 52 by the supply pressure and sprayed in the lateral direction. That is, the sharp-edged bar 52 is inserted into the battery pack of the electric vehicle so that the fire extinguishing agent is sprayed inside the battery pack, contributing to rapid stabilization of the battery pack.

In addition, the hydraulic/pneumatic cylinder 53 moves the sharp-edged bar 52 in the vertical direction. The hydraulic/pneumatic cylinder 53 is fixed inside the perforating housing 51 such that only a cylinder rod is drawn out, and the cylinder rod is connected to the lower portion of the sharp-edged bar 52 by a rotating connection bar, and the rotating connection bar rotates about a fixed hinge. When the cylinder rod is discharged from the hydraulic/pneumatic cylinder 53, the discharge force may be transmitted to the sharp-edged bar through the rotating connection bar so that the sharp-edged bar 52 may move up and down.

Meanwhile, as shown in FIG. 5B, the perforating housing 51 may be further elevated such that the lower surface of the electric vehicle and the perforating housing 51 are closely arranged to minimize the protruding length of the sharp-edged bar 52 while the sharp-edged bar penetrate into the battery pack, thereby injecting the fire extinguishing agent.

A drain hole or drain line for discharging the fire extinguishing agent introduced during the fire extinguishing process to the outside may be further formed inside the perforating housing or in the floor space where the perforating housing is received, and a check valve may be installed on the drain line so as to be closed not to discharge the fire extinguishing agent in the process of operation of the fire blocking/extinguishing apparatus such that a certain amount of fire extinguishing agent is retained inside the flame-retardant cover to provide a water bath function for extinguishing.

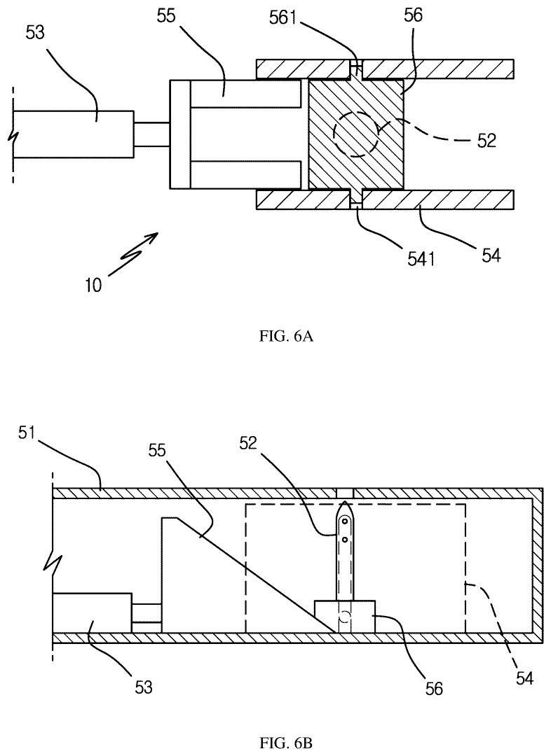

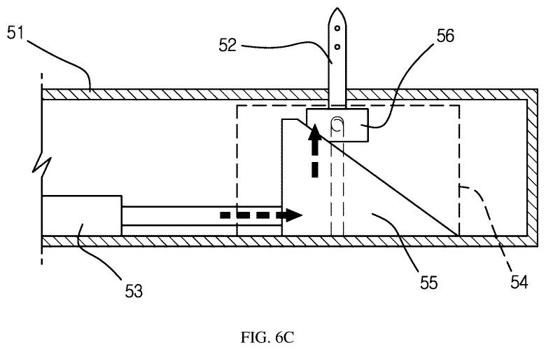

FIG. 6A is a plan view illustrating another embodiment of a perforating fire extinguishing apparatus according to the present disclosure, and FIGS. 6B and 6C are operational state diagrams thereof.

Referring to drawings, a perforating fire extinguishing apparatus 50 according to another embodiment of the present disclosure may move an inclined plate 55 using hydraulic/pneumatic pressure, and a sharp-edged bar 52 may be placed on the inclined plate so as to move up and down along the inclined surface such that the sharp-edged bar moves in the vertical direction by the inclined plate, which may be installed inside the perforating housing.

As shown in the drawings, the perforating fire extinguishing apparatus 50 of the present disclosure has a plurality of guide walls 54 installed in parallel at regular intervals on the bottom of the inner space of the perforating housing 51. Vertical guide holes 541 are formed in the guide walls 54 so as to face each other, and lifting protrusions 561 of a lifting block 56, which will be described later, are inserted into the vertical guide holes 541 to guide the movement of the lifting block only in the vertical direction. Accordingly, it is preferable that the width of the vertical guide hole 541 is the same as that of the lifting protrusion of the lifting block or provided in a form having a clearance to enable vertical movement.

An inclined plate 55 is disposed at the bottom between the two guide walls so as to move forward and backward. The inclined plate 55 is a triangular wall whose upper surface is configured as an inclined surface having an upward slope from the front end to the rear side. The inclined plate 55 may be formed as a single inclined plate or provided in a form in which a pair of left and right plates is provided and in which a connection portion is formed at the rear thereof. The inclined plate 55 may be coupled to the bottom surface of the perforating housing through rails so as to move only in the forward and backward directions along the rails.

A hydraulic/pneumatic cylinder 53 is coupled to the rear side of the inclined plate. The hydraulic/pneumatic cylinder receives the hydraulic/pneumatic pressure and pushes a rod to push or pull the inclined plate 55 to move forward and backward.

The lifting block 56 has lifting protrusions 561 formed on both sides thereof, and the lifting protrusions 561 are inserted into the vertical guide holes 541 of the guide walls 54 so that the lifting block moves only in the vertical direction. In addition, the entire or partial surface of the rear side where the inclined plate is located on the bottom may be formed as an inclined surface corresponding to the inclined surface in the upper portion of the inclined plate. Therefore, if the inclined plate moves forward by the operation of the hydraulic/pneumatic cylinder, the lifting block slides while being guided by the inclined surface in the upper portion of the inclined plate, thereby moving up or down

The sharp-edged bar 52 is coupled to the upper portion of the lifting block. As described above, the sharp-edged bar has internal passages and perforated outlets formed therein, and the internal passage is directly connected to an extinguishing agent tank through an agent supply pipe or leads thereto through the lifting block 56 to receive a fire extinguishing agent.

The sharp-edged bars 52 may be arranged in a zigzag form on both sides of the perforating housing, and in this case, the hydraulic/pneumatic cylinders may also be arranged in a zigzag form to minimize the installation area.

As described above, the fire suppression system 10 of the electric vehicle charging station according to the present disclosure makes it possible to quickly determine whether or not a fire occurs by the camera measurement apparatus 30 and prevent the spread of flame in case of fire by unfolding the flame-retardant cover 44 of the fire blocking/extinguishing apparatus 40.

If an electric vehicle fire occurs in the charging area, a fire extinguishing agent is injected into the flow passage of the flame-retardant cover 44, and the flow passage expands in volume due to the injection pressure of the fire extinguishing agent so that the flame-retardant cover quickly unfolds, and the unfolded flame-retardant cover covers the electric vehicle on fire to block the flame, and the spray nozzles 464 inside the flame-retardant cover spray the supplied fire extinguishing agent to the electric vehicle, thereby quickly extinguishing the fire. In particular, as the flame-retardant cover comes into close contact with the floor of the charging station, the fire extinguishing agent sprayed by the spray nozzle 464 may be retained inside the flame-retardant cover to provide a water bath function, and the fire extinguishing agent, when retained sufficiently, may be discharged to the outside through the discharge means 47, thereby reducing the amount of the fire extinguishing agent sprayed through the spray nozzle.

In addition, the perforating fire extinguishing apparatus 50 installed on the floor of the charging station may move the sharp-edged bar 52 up to penetrate the battery pack through the floor of the electric vehicle and enter the inside thereof so that the fire extinguishing agent is injected into the battery pack to stabilize the same and enable internal fire extinguishing, thereby providing a useful system capable of extinguishing a fire by performing fire extinguishing only by the flame-retardant cover or by simultaneously performing fire extinguishing inside and outside the battery through the perforating fire extinguishing apparatus.

1. A fire suppression system of an electric vehicle charging station, the fire suppression system comprising:
a charging apparatus installed on one side of a charging area where an electric vehicle is parked and configured to supply electricity to the parked electric vehicle to charge the same;
a camera measurement apparatus installed on the front, rear, and floor of the charging area and configured to take general images and thermal images of the electric vehicle;
a fire blocking/extinguishing apparatus comprising a multi-folded flame-retardant cover installed above the electric vehicle charging area such that the flame-retardant cover unfolds during fire extinguishing to form a dome-shaped sealed space to cover the electric vehicle, thereby blocking the flame from being exposed to the outside, and a plurality of nozzles formed on the inner surface of the flame-retardant cover so as to spray a fire extinguishing agent supplied from an extinguishing agent tank, thereby extinguishing fire of the electric vehicle enclosed therein; and
a control apparatus configured to provide the general images and thermal images received from the camera measurement apparatus to a manager and operate the fire blocking/extinguishing apparatus by receiving an operation signal.

2. The fire suppression system of an electric vehicle charging station of claim 1, wherein the fire blocking/extinguishing apparatus further comprises:
a transfer pipe having an inlet connected to the extinguishing agent tank and an outlet disposed above the charging area of the electric vehicle; and
a flame-retardant housing mounted in a box shape at the outlet of the transfer pipe and having an opening/closing door on the lower surface thereof, and
wherein the flame-retardant cover is folded and stored inside the flame-retardant housing.

3. The fire suppression system of an electric vehicle charging station of claim 1, wherein the flame-retardant cover is configured to comprise:
a dome-shaped main cover formed by laminating flame-retardant materials in a multi-layer;
a flow passage formed in a portion of the main cover and configured to transfer the fire extinguishing agent supplied from the extinguishing agent tank, maintain the main cover in a dome shape by the pressure of the fire extinguishing agent, and come into close contact with the floor of the charging area to form a sealed space in which the vehicle is placed;
a spray nozzle formed on the inner surface of the sealed space in the flow passage to spray the transferred fire extinguishing agent into the sealed space; and
a discharge means formed on the main cover that does not have the flow passage and configured to discharge the fire extinguishing agent retained in the sealed space to the outside to prevent the fire extinguishing agent from being stored above a certain level.

4. The fire suppression system of an electric vehicle charging station of claim 3, wherein the discharge means is a plurality of check valves mounted at a height 20 to 30 cm higher than the battery mounting height of the electric vehicle and configured to discharge the stored fire extinguishing agent to the outside.

5. The fire suppression system of an electric vehicle charging station of claim 4, wherein the discharge means is equipped with a detection sensor configured to detect whether or not the fire extinguishing agent is discharged, and
wherein when the detection sensor detects the discharge of the fire extinguishing agent, the amount of fire extinguishing agent discharged from the extinguishing agent tank is adjusted to reduce the amount of fire extinguishing agent used.

6. The fire suppression system of an electric vehicle charging station of claim 3, wherein the flow passage is configured to comprise:
a plurality of radial passages radially formed at a point connected to the discharge pipe outlet, configured to unfold the central portion of the flame-retardant cover to the side, and having spray nozzles formed toward the sealed space;
vertical passages disposed vertically to have one end leading to the radial passage and a lower portion extending outwards, thereby increasing the internal area, and having spray nozzles formed toward the sealed space; and
bottom passages connecting adjacent vertical passages among the plurality of vertical passages to close the same in a circle or rectangular shape and coming into close contact with the floor of the charging area by the weight of the fire extinguishing agent injected therein, thereby retaining the fire extinguishing agent sprayed therein.

7. The fire suppression system of an electric vehicle charging station of claim 1, wherein a perforating fire extinguishing apparatus configured to move a plurality of sharp-edged bars up in case of fire of the electric vehicle battery so as to penetrate the bottom of the electric vehicle and enter the battery, inject the fire extinguishing agent supplied from the extinguishing agent tank into the battery through the sharp-edged bars, thereby extinguishing the fire, is buried in the floor of the electric vehicle charging area, and
wherein the control apparatus is configured to operate one of either the fire blocking/extinguishing apparatus or the perforating fire extinguishing apparatus or both of them for fire suppression.

8. The fire suppression system of an electric vehicle charging station of claim 7, wherein the perforating fire extinguishing apparatus is configured to comprise:
a perforating housing buried in the floor of the electric vehicle charging area to provide an installation space;
a sharp-edged bar installed vertically inside the perforating housing and having an agent supply pipe configured to supply the fire extinguishing agent of the extinguishing agent tank, which is connected to one side of the lower portion thereof, and a perforated outlet configured to discharge the fire extinguishing agent supplied through the agent supply pipe to the outside through an internal passage, which is formed at the upper end or one side of the upper portion; and
a hydraulic/pneumatic cylinder configured to transfer hydraulic/pneumatic pressure to the sharp-edged bar to move the same up and down.

9. The fire suppression system of an electric vehicle charging station of claim 7, wherein the perforating fire extinguishing apparatus is configured to comprise:
a perforating housing buried in the floor of the electric vehicle charging area to provide an installation space;
a plurality of guide walls arranged in a wall structure in parallel at regular intervals on the bottom inside the perforating housing and having vertical guide holes formed on opposite inner surfaces;
an inclined plate, which is a triangular wall having an inclined surface from the front to the rear on the upper surface thereof, installed to move forward and backward in the longitudinal direction between the two guide walls disposed in parallel;
a hydraulic/pneumatic cylinder connected to the rear side of the inclined plate and moving the inclined plate forward and backward;
a lifting block having lifting protrusions formed on both sides to be inserted into the vertical guide holes of the guide walls so as to move only in the vertical direction and an inclined surface, corresponding to the inclined surface of the inclined plate, formed on a partial or entire surface of the rear side of the bottom to slide along the inclined plate, thereby moving up and down; and
a sharp-edged bar vertically installed on the upper portion of the lifting block and having an agent supply pipe configured to supply the fire extinguishing agent of the extinguishing agent tank, which is connected directly or through the lifting block to one side of the lower portion thereof and a perforated outlet configured to discharge the fire extinguishing agent supplied through the agent supply pipe to the outside through an internal passage, which is formed at the upper end or one side of the upper portion.

10. The fire suppression system of an electric vehicle charging station of claim 1, wherein the control apparatus performs control comprising:
an image measurement step of securing an image of the electric vehicle through the camera measurement apparatus;
an image analysis step of checking whether or not smoke or flame is generated through measured image information and continuously analyzing whether or not the battery temperature is higher than a configured temperature to identify a pattern;
a pattern determination step of comparing an analysis pattern of the image information analyzed in the image analysis step with a stored pattern to determine whether the pattern is a normal pattern or an abnormal pattern;
a manager confirmation information input step of, when the analysis pattern of the image information is determined to be similar to the abnormal pattern, giving a notification to a manager through an alarm while cutting off the charging power or transmitting the image to a registered manager terminal and receiving confirmation information to confirm whether there is a fire;
a final decision step of, when manager confirmation information is filling a fire extinguishing agent, connecting to a registered fire station terminal to provide image information and receiving fire extinguishing execution information from the fire station terminal; and
a fire extinguishing apparatus operation step of supplying power to a single or a plurality of fire extinguishing apparatus to be operated when the fire extinguishing execution information is received.
